(19) United States
(12) Patent Application Publication
(10) Pub. No.: US 2015/0178848 A1
(43) Pub. Date: Jun. 25, 2015

(54) SYSTEMS AND METHODS FOR FINANCIAL PROPOSAL GENERATION

(71) Applicant: Fiserv, Inc., Brookfield, WI (US)

(72) Inventors: Pierre Gabriel Bossaert, Aptos, CA (US); Michael Zhengmao Ji, Palo Alto, CA (US)

(21) Appl. No.: 14/636,680

(22) Filed: Mar. 3, 2015

Related U.S. Application Data
(63) Continuation of application No. 14/014,955, filed on Aug. 30, 2013.
(60) Provisional application No. 61/791,720, filed on Mar. 15, 2013.

(51) Int. Cl. G06Q 40/06

(52) U.S. Cl. CPC G06Q 40/06

(57) ABSTRACT

Systems and methods that receive personal and/or financial information associated with a customer and a proposed financial action are disclosed. Based, at least in part on the received information, and iterative analysis of the financial implications of the proposed financial action, a financial proposal is generated. The financial proposal may provide insight into one or more optimized times and/or optimized amounts for executing the proposed financial action.

### CROSS-REFERENCE TO RELATED APPLICATIONS

This application is a continuation of U.S. application Ser. No. 14/014,955, filed Aug. 30, 2013, which claims priority to U.S. Provisional Application No. 61/791,720, filed Mar. 15, 2013, the contents of which are incorporated by reference herein in their entirety.

### FIELD OF THE DISCLOSURE

The present disclosure relates to systems and methods for financial proposal generation.

### BACKGROUND OF THE DISCLOSURE

Individuals and/or financial advisors, on behalf of individuals, may engage in financial planning. This financial planning may be based on a variety of personal and/or financial information, such as current age, desired retirement age, current income, expected income growth, tax filing status, or the like. The financial planning may provide guidance to the individual about whether their financial goals, such as paying for education or entering retirement, are on track. In some cases, the financial planning may take into account changes in taxation in the future when providing financial planning. In general, financial planning is geared towards developing a plan for achieving desired financial goals, rather than determining timing of executing particular financial actions.

### BRIEF DESCRIPTION OF THE FIGURES

Reference will now be made to the accompanying drawings, which are not necessarily drawn to scale, and wherein:

FIG. 1 is a simplified schematic diagram illustrating an example ecosystem for generating a financial proposal, in accordance with illustrative embodiments of the disclosure.

FIG. 2 is a simplified schematic diagram illustrating one or more financial advice system server(s) as part of the example architecture of FIG. 1, in accordance with illustrative embodiments of the disclosure.

FIG. 3 is a simplified schematic diagram illustrating an example interaction with the financial advice system servers of FIG. 2 to generate a financial proposal, in accordance with illustrative embodiments of the disclosure.

FIG. 4 is a flow diagram illustrating an example method for generating and transmitting a financial proposal, in accordance with illustrative embodiments of the disclosure.

FIG. 5 is a flow diagram illustrating an example method for generating an action optimization proposal, in accordance with illustrative embodiments of the disclosure.

### DETAILED DESCRIPTION OF EMBODIMENTS OF THE DISCLOSURE

Embodiments of the disclosure are described more fully hereinafter with reference to the accompanying drawings, in which embodiments of the disclosure are shown. This disclosure may, however, be embodied in many different forms and should not be construed as limited to the embodiments set forth herein; rather, these embodiments are provided so that this disclosure will be thorough and complete, and will fully convey the scope of the disclosure to those skilled in the art. Like numbers refer to like elements throughout.

The systems and methods, as disclosed herein, may provide a financial proposal associated with a proposed financial action. The proposed financial action may include investment related actions. In some cases, the proposed financial action may have tax implications. Examples of proposed financial transactions may include converting a traditional individual retirement account (IRA) to a Roth IRA account or exercising stock options. The financial proposal may provide timing, such as one or more relatively optimal years or span of years, for performing the proposed financial action. In certain embodiments of the disclosure, the relatively optimal times for performing the financial action may result in an overall reduction in taxes paid over a span of time, such as the expected lifetime of an associated customer and/or investor. Certain financial actions may increase a tax burden in a given year, whereas others may reduce the tax burden. Example financial actions include exercising a stock option and converting a traditional IRA to a Roth IRA.

In certain embodiments, the financial proposal may be generated based, at least in part, on income, expense, tax, demographic, life goal/event data, and assumptions associated with the customer and/or investor. Multiple optimal times may be identified, e.g., for both pre-retirement and post-retirement periods of the customer and/or investor, or spanning several specific (not necessarily consecutive) years if an action is significant enough that it should be spread over several years. Therefore, the financial proposal may include an optimized action, optimized amount of the optimized action, and/or an optimized timing of the optimized action. The financial proposal may provide timing for a financial action that may maximize, or at least increase, wealth and/or maximize, or at least increase, income. The financial proposal may be generated and transmitted to one or more user interfaces by a financial advice system that may include one or more servers, referred to as financial advice system servers.

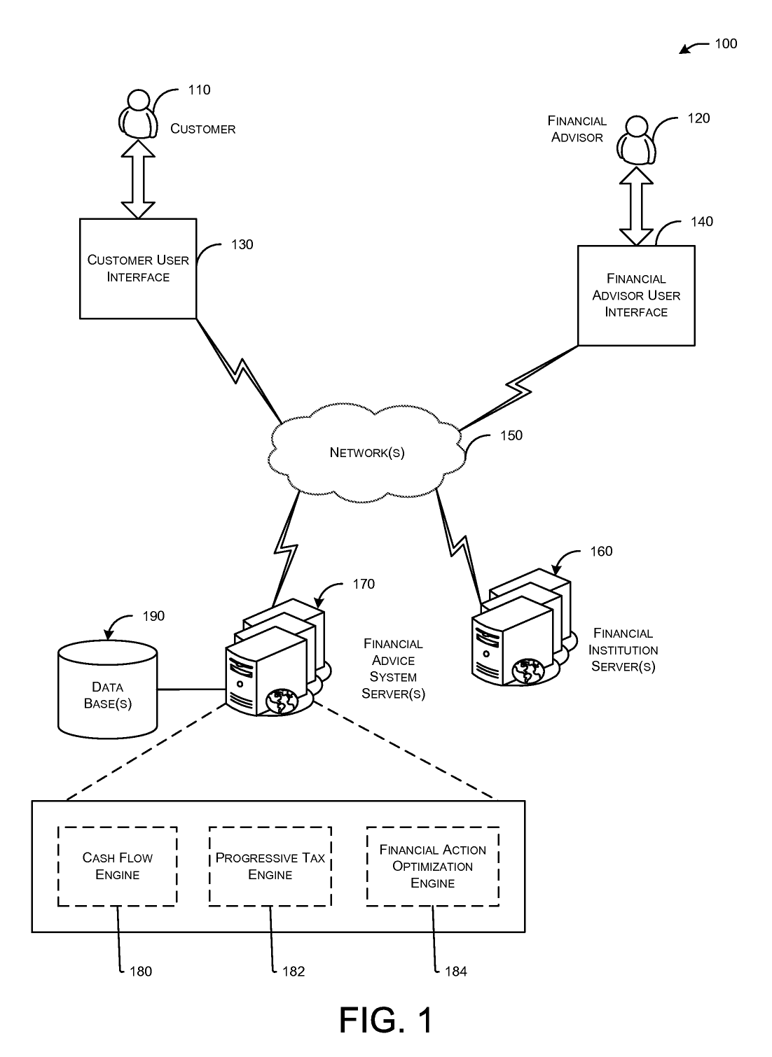

Referring now to FIG. 1 an example ecosystem 100 for generating a financial proposal, in accordance with illustrative embodiments of the disclosure is described. The ecosystem 100 may include a customer 110 or investor that may interact with a customer user interface 130 and/or a financial advisor 120 that may interact with a financial advisor user interface 140 to access a financial advisor system, that may include one or more financial advice system servers 170 via one or more networks 150. The ecosystem 100 may further include one or more financial institution computers 160 that may also be communicatively coupled to the one or more networks 150.

In certain embodiments, the financial advisor 120 may be a primary user of the financial advice system, and the functions provided therein, to generate and provide financial advice to the customer 110. This financial advice may include tone or more financial proposals generated by the financial advice system and associated with one or more proposed financial actions. In other embodiments, the customer 110, such as an individual investor, may interact directly with the financial advice system servers 170, and the functions thereof, or portions thereof, to generate his/her own financial advice, such as a financial proposal generation associated with one or more proposed financial actions. In other words, the financial advice system servers 170 may support self-directed or do-it-yourself investors. In some cases, the functionality of the financial advice system servers 170 may be provided to one or more customers via third party sources. For example, a financial institution, employer, and/or securities brokerage company may contract with a controlling entity of the financial advice system servers 170 to provide financial proposal generation functionality of the financial advice system servers 170 to their clients, customers, and/or employees. In further cases, both the customer 110 and the financial advisor 120 may be able to cooperate to provide information and/or instantiate the generation of a financial proposal by the financial advice system servers 170. For example, in certain example embodiments, the financial advisor 120 may provide some information associated with the customer 110 and the customer 110 may provide other information associated with himself/herself.

The customer 110 may interact with the financial advice system servers 170 via any suitable mechanism, such as the customer user interface 130. It will be appreciated that in certain embodiments, the customer 110 may interact with the advisor system 170 via more than one customer user interface 130. For example, the customer 110 may access the financial advice system servers 170 via a personal computer, smart phone, and/or tablet. In certain embodiments, the customer user interface 130 may be a Web-based client and may be rendered on a user device associated with the customer 110. In this case, the customer user interface 130 may be displayed on the user device associated with the customer 110 using a Web browser application software, or similar application, for rendering Web pages. Alternatively, the customer user interface 130 may be an application and/or software on the user device, such as a mobile application rendering the customer user interface 130. The customer user interface 130 may be utilized to provide input or import of personal and/or financial data and parameters, the triggering of appropriate financial proposal generation functionality, and the display or export of various results, such as of a financial action optimization processing and/or the financial proposal. The user device as used herein, may include, but is not limited to, desktop computers, laptop computers, netbook computers, personal digital assistants (PDA), tablet computing devices, smart phones, Web enabled televisions, or combinations thereof. Alternatively, the customer user interface 130 may be one or more third-party client application(s), such as electronic mail (email) client, file transfer utility, report writer, or the like, for obtaining reports or mining data. The customer user interface 130 may be configured to render a report thereon, such as a financial proposal report or similar and/or associated reports. The customer user interface 130 may further be configured to print and/or initiate printing of a report, such as a financial proposal report or other reports received from the financial advice system servers 170.

The financial advisor 120 may interact with the financial advice system servers 170 via any suitable mechanism, such as the financial advisor user interface 140. It will be appreciated that in certain embodiments, the financial advisor 120 may interact with the financial advice system servers 170 via more than one financial advisor user interface 140. For example, the financial advisor 120 may access the financial advice system servers 170 via a personal computer, smart phone, and/or tablet. In certain embodiments, the financial advisor user interface 140 may be a Web-based client and may be rendered on a user device associated with the financial advisor 120. In this case, the financial advisor user interface 140 may be displayed on a user device associated with the financial advisor 120 using a Web browser application software, or similar application, for rendering Web pages. Alternatively, the financial advisor user interface 140 may be an application and/or software on a user device, such as a mobile application rendering the financial advisor user interface 140. The financial advisor user interface 140 may be utilized to provide input or import of personal and/or financial data and parameters, the triggering of appropriate financial proposal generation functionality, and the display or export of various results, such as of a financial action optimization processing and/or the financial proposal. Alternatively, the financial advisor user interface 140 may be one or more third-party client application(s), such as electronic mail (email) client, file transfer utility, report writer, or the like, for obtaining reports or mining data. The financial advisor user interface 140 may be configured to render a report thereon, such as a financial proposal report or similar and/or associated reports. The financial advisor user interface 140 may further be configured to print and/or initiate printing of a report, such as a financial proposal report or other reports received from the financial advice system servers 170.

The networks 150 may include any one of or a combination of different types of suitable communications networks, either local area or wide area, such as cable networks, the internet, wireless networks, cellular networks and other private and/or public networks. Furthermore, the networks 150 may include any variety of medium over which network traffic is carried, including but not limited to, coaxial cable, twisted wire pair, optical fiber, hybrid fiber coaxial, HFC, microwave, terrestrial transceivers, radio frequency communications, satellite communications or combinations thereof.

The financial institution servers 160 may be associated with one or more financial institutions. The customer 110 may have one or more financial accounts and/or may consider opening one or more financial accounts at the one or more financial institutions associated with the financial institution servers 160. The financial institution servers 160 may be configured to receive financial transactions and/or instructions, such as on behalf of the customer 110, via the one or more networks 150 to perform one or more financial actions at the corresponding financial institution.

The financial advice system servers 170 and the functionality associate therewith may be hosted, maintained, and/or located at a financial institution or with a third party entity. In other words, financial proposal services provided by the financial advice system servers 170 may be provided by a financial institution or a third party service provider. The financial advice system servers 170 may include one or more of a cash flow engine component 180, progressive tax engine component 182, and a financial action optimization engine component 184. Functionality represented by these components may be combined or kept separate. It will be appreciated that the financial advice system servers 170 may include other components and/or software modules, other than those components 180, 182, 184, to provide other varied functionality that may interact with the depicted components 180, 182, 184. The financial advice system servers 170 may further be configured to communicate and utilize one or more databases 190, for storing data and/or other information associated with the financial proposal generation functionality of the financial advice system servers 170. Services provided by the financial advice system servers 170 may support financial professionals, such as financial advisors 120, in various functions associated with financial and retirement planning such as client relationship management, portfolio construction or management, asset allocation, proposal generation, investor needs, risk analysis, and investment or retirement income asset sales. The services of the financial advice system servers 170 may be configured so that separate functionality may be mixed-and-matched to support the variety of functions the financial advisor 120 performs. This may be accomplished by all of the components 180, 182, 184 accessing a single database or group of databases, such as the databases 190, of the customer's personal, financial, and/or account information.

The financial advice system servers 170 and related services enable the financial advisor 120 or other investment professional to deliver higher quality financial advice and create customized financial plans for the various financial and lifestyle goals of each customer 110. They may also enable relatively greater collaboration between the financial advisor 120 and the customer 110 to design, monitor, and report on financial plans based on goals. The financial advice system servers 170 enable the financial advisor 120 to provide customized financial plans with indication of financial actions, amounts associated with the financial actions, and timing associated with the financial actions.

The cash flow engine component 180 may be configured to maintain and process comprehensive cash flow data associated with the customer 110 in preparation for further processing by the progressive tax engine component 182, financial action optimization engine component 184, and potentially other financial advice system servers components.

The progressive tax engine component 182 may be configured to compute a tax obligation, such as Federal tax obligation(s), iteratively for a span of years, such as future years. The progressive tax engine component 182 may be configured to compute Federal tax obligation(s) from the current year to the end of life expectancy of the customer 110, utilizing profile data and/or comprehensive cash flow data that may be determined by the financial advice system servers 170 and/or stored in the databases 190. While the discussion provided herein may be in the context of Federal tax, it will be appreciated that the systems and methods disclosed may be applied to any type of taxation, including state, city, county, foreign, property, sales, combinations thereof, or the like.

Financial action optimization component 184 may be configured to analyze the output of the progressive tax engine component 182 to identify optimal years for investment and other financial actions that may have tax implications for the customer 110.

It will be appreciated that the financial advice system severs 170 (or an equivalent financial advice system) may comprise other system components (either software or data) that have not been depicted here.

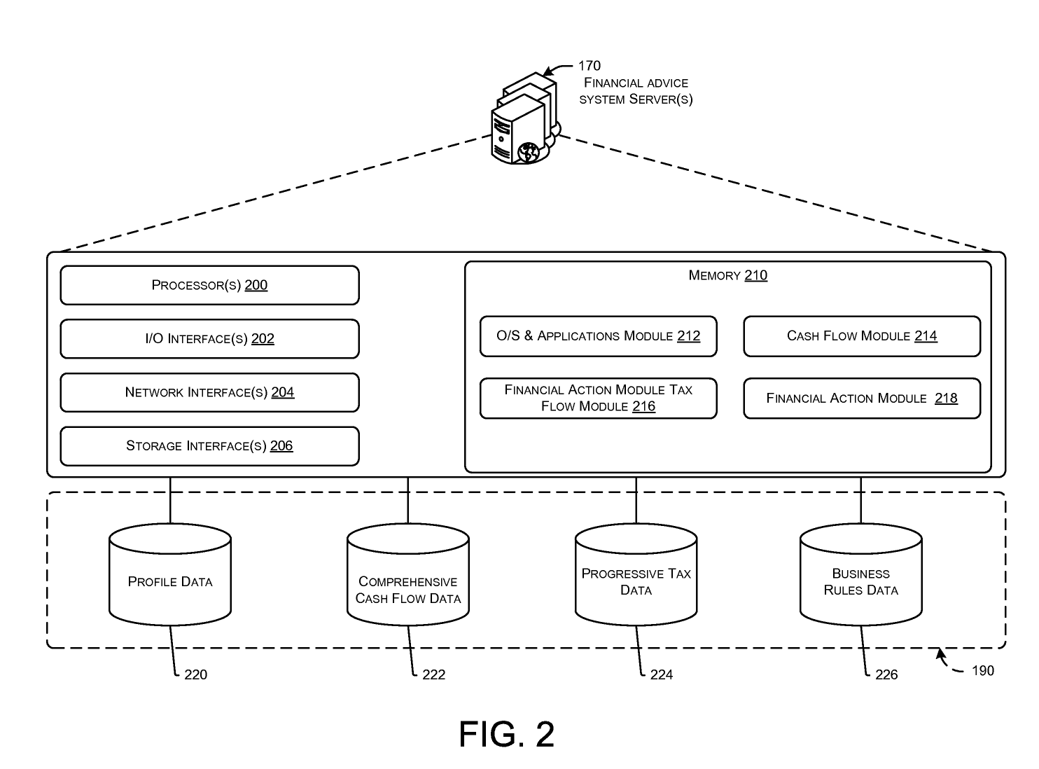

Referring now to FIG. 2 an example configuration of the financial advice system servers 170, in accordance with embodiments of the disclosure, is discussed. The financial advice system servers 170 may include one or more processors 200, one or more input/output (I/O) interfaces 202, one or more network interfaces 204, one or more storage interfaces 206, and one or more memories 210. These financial advice system server components may be interconnected by one or more internal communication mechanisms, such as a bus (not shown).

The one or more processors 200 may be configured to execute and/or operate one or more instructions, applications, and/or software in one or more memories 210 of the financial advice system servers 170 to provide services to the customers 110 and/or financial advisors 120 of financial planning and financial proposal generation. In some examples, the one or more processors 200 of the financial advice system servers 170 may be implemented as appropriate in hardware, software, firmware, or combinations thereof. Software or firmware implementations of the one or more processors 200 may include computer-executable or machine-executable instructions written in any suitable programming language to perform the various functions described. Hardware implementations of the processors 200 may be configured to execute computer-executable or machine-executable instructions to perform the various functions described. The one or more processors 200 may include, without limitation, a central processing unit (CPU), a digital signal processor (DSP), a reduced instruction set computer (RISC), a complex instruction set computer (CISC), a microprocessor, a microcontroller, a field programmable gate array (FPGA), or any combination thereof. The financial advice system servers 170 may also include a chipset (not shown) for controlling communications between the one or more processors 200 and one or more of the other components of the financial advice system servers 170. The one or more processors 200 may also include one or more application specific integrated circuits (ASICs) or application specific standard products (ASSPs) for handling specific data processing functions or tasks.

The I/O interfaces(s) 202, may include any suitable interface configured to interface between the processors 200 and input/output components, such as a display, speakers, keyboard, mouse, or the like, of the financial advice system servers 170. The network interfaces(s) 204 may allow the financial advice system servers 170 to communicate with remotely stored databases or files, other computing devices or servers, user terminals, and/or other devices (e.g., printers) on the networks 150 or other suitable communicative channels. The one or more storage interfaces 206 may enable the financial advice system servers 170 and the processors 200, thereon, to communicate with one or more local internal or external storage devices that may comprise databases 190 and/or constituent databases of profile database 220, comprehensive cash flow database 222, progressive tax database 224, and business rules database 226.

The memory 210 may include one or more volatile and/or non-volatile memory devices including, but not limited to, random access memory (RAM), dynamic RAM (DRAM), static RAM (SRAM), synchronous dynamic RAM (SDRAM), double data rate (DDR) SDRAM (DDR-SDRAM), RAM-BUS DRAM (RDRAM), flash memory devices, electrically erasable programmable read only memory (EEPROM), non-volatile RAM (NVRAM), universal serial bus (USB) removable memory, or combinations thereof. The memory 210 may store program instructions that are loadable and executable on the processor(s) 200, as well as data generated or received during the execution of these programs. Turning to the contents of the memory 210 in more detail, the memory 210 may include an operating system (0/S) and applications module 212, cash flow module 214, a financial action module 218, and a progressive tax module 216. Each of the modules and/or software may provide functionality for the financial advice system servers 170, when executed by the processors 200. The modules and/or the software may or may not correspond to physical locations and/or addresses in memory 210. In other words, the contents of each of the modules may not be segregated from each other and may, in fact be stored in at least partially interleaved positions on the memory 210. In certain embodiments, each of the modules 212, 214, 216, 218 may be divided with greater granularity. In other words, each of the modules 212, 214, 216, 218 may include sub-modules.

The O/S and applications module 212 may have one or more operating systems (0/S) stored therein. The processors 200 may be configured to access and execute one or more of the O/S to operate system functions of the financial advice system servers 170. System functions, as managed by the O/S and applications module 212 may include memory management, processor resource management, driver management, application software management, system configuration, and the like. The O/S may be any variety of suitable operating systems including, but not limited to, Google® Android®, Microsoft® Windows®, Microsoft® Windows® Server®, Linux, Apple® OS-X®, Apple® iOS®, or the like. In other words, the O/S may be the framework under which the customer 110 and/or the financial advisor 120 may interact with the financial advice system servers 170. The O/S and applications module 212 may further have one or more software applications stored thereon that may be accessed and executed by the processors 200 to provide various functionality of the financial advice system servers 170, including financial proposal generation.

The cash flow module 214 may have instructions stored therein that when executed by the one or more processors 200 may configure the processors 200 to provide a variety of functionality associated with determining a cash flow associated with the customer 110 by the financial advice system servers 170. The processors 200 may be configured to maintain and process comprehensive cash flow data in preparation for processing by the functions enabled by the progressive tax module 216, financial action module 218, and potentially other financial advice system server 170 functionality. In certain example embodiments, the processors 200 may determine the cash flow, such as cash flow for multiple years from a start year to an end year, based at least in part on information associated with the customer 110, as provided to the financial advice system servers 170 by one or both of the customer 110 and/or financial advisor 120. For example, cash flow may be determined by the processors 200 based on customer information, such as income, expected income growth rate, expected inflation rate, expected social security payments, or the like. In some example embodiments, the cash flow module 214 may be a part of and/or cooperate with the cash flow engine component 180.

The progressive tax module 216 may have instructions stored therein that when executed by the one or more processors 200 may provide a variety of functionality associated with determining one or more taxes by the financial advice system servers 170. The processors 200 may be configured to compute Federal tax obligation(s) from the current year to the end of life expectancy of the customer 110, utilizing profile data and/or comprehensive cash flow data that may be determined by the financial advice system servers 170 and/or stored in the databases 190. In some embodiments, the progressive tax module 216 may be a part of and/or cooperate with the progressive tax engine component 182.

The financial action module 218 may have instructions stored therein that when executed by the one or more processors 200 may provide a variety of functionality associated with providing a financial action by the financial advice system servers 170. The processors 200 may be configured to analyze the output of the functionality enabled by the progressive tax module 216 to automatically identify optimal years for investment and other financial actions that may have tax implications for the customer 110. In some embodiments, the financial action module 218 may be a part of and/or cooperate with the financial action optimization engine component 184.

The financial advice system servers 170 may be configured to access, store, use, and/or modify profile data on the profile database 220. The profile database may include personal data associated with the customer 110 that may span multiple years. This data may include, but is not limited to, tax filing status, dependents, age(s) (self, spouse, dependents), tax withholding, carryover(s) or carry forwards (charitable donation, minimum tax credit, alternative minimum tax (AMT), capital loss), or the like.

The financial advice system servers 170 may be configured to access, store, use, and/or modify comprehensive cash flow data on the comprehensive cash flow database 222. This data may include, but is not limited to, current year data associated with the customer 110, such as assets (financial/non-financial, qualified/non-qualified, trust, taxable/tax-deferred/tax-free), liabilities (customer 110/spouse/joint), income (earned income, self-employment income, social security income, interest income, capital gains, taxable/tax-free), expenses (tax expenses (e.g., state, local, property), interest expenses (e.g., mortgage), charitable donation expenses, professional expenses, estate expenses, and/or educational expenses). The comprehensive cash flow database 222 may further include information and/or data related to investment goals and objectives and life event assumptions associated with the customer. This may include data associated with retirement, education, accumulation, emergency fund, debt management, survivor income, long term care, disability income, stock options, and/or advanced estate planning data.

The comprehensive cash flow data stored in the comprehensive cash flow database 222 may yet further include a subset of progressive tax data calculated by the progressive tax engine component 182 and placed on the progressive tax database 224. This data may include tax/refund due and/or tax withheld.

The progressive tax engine component 182 may be configured to determine and store a set of additional tax-related values for each of the years in the multiple years or span of time of analysis associated with the customer 110. This progressive tax data may be stored in the progressive tax database 224 and may include data for each year of the analysis time span. This data may include total income, total investment income, total adjustments, adjusted gross income (AGI), total deductions, taxable income, federal income tax, Alternative Minimum Tax (AMT), tax credits, net capital gain/loss, capital gains tax, capital loss carry-over, other taxes, total taxes, tax/refund due, effective tax rate (tax bracket), low boundary income for tax bracket, high boundary income for tax bracket, earned income tax credit, or the like.

The business rules database 226 may be an optional data repository that may be configured to store rules that may be read and executed by the financial action optimization functionality enabled by the instructions in the financial action module 218 in a “rules engine” manner. In some cases, these rules, and functionality supported therewith, may be beneficial for supporting flexible processing. The financial action optimization methods disclosed herein do not assume or leverage any separate business rules (i.e., the processing logic is internal to the financial action optimization engine component 184 and/or the functionality enabled by the financial action module 218).

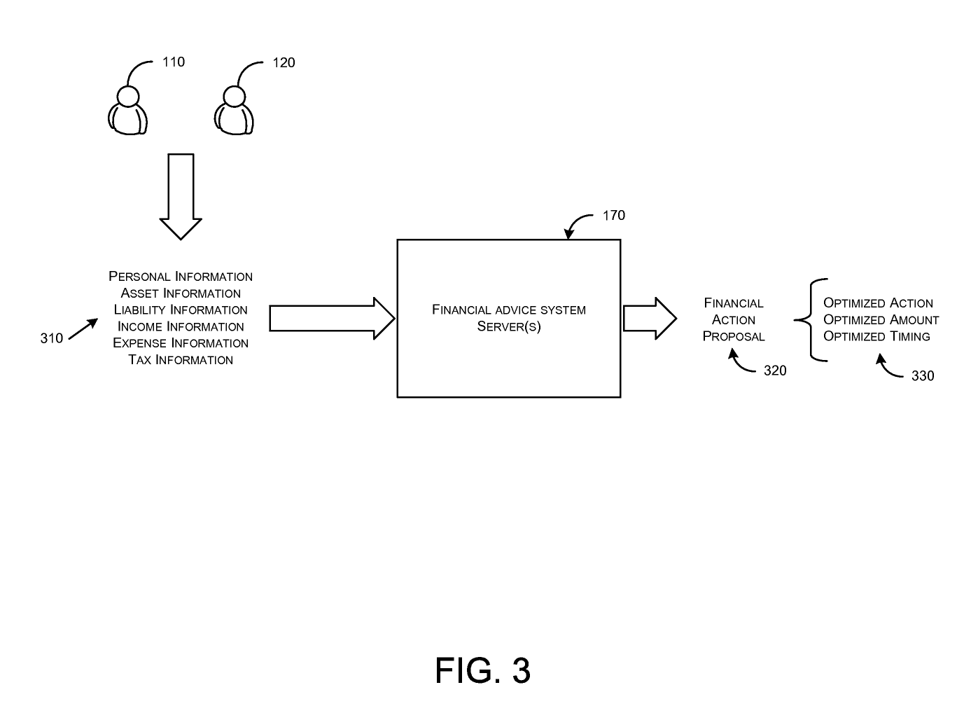

Referring now to FIG. 3, an example interaction 300 with the financial advice system servers 170 to generate a financial proposal, in accordance with illustrative embodiments of the disclosure, is described. The customer 110 and/or the financial advisor 120 may provide a variety of information 310 pertaining to the customer 110 to the financial advice system servers 170. In some cases, this information may be provided by the customer 110, such as via his/her customer user interface 130. In other cases, this information may be provided by the financial advisor 120, such as via his/her financial advisor user interface 140. In yet other cases, some of this information 310 may be provided by the customer 110 and other of this information 310 may be provided by the financial advisor 120, using their respective user interfaces 130, 140. This information may include, but is not limited to, personal information, asset information, liability information, income information, and/or tax information. The financial advice system servers 170 may analyze the information 310 received and provide a financial proposal 320 based, at least in part on the information 310. The financial proposal 320 may include one or more actionable elements 330, such as an optimized action, an optimized amount associated with the optimized action, and/or an optimized timing associated with the optimized action. These actionable elements 330 and, indeed the financial proposal 320 in its entirety, may be transmitted to one or both of the customer user interface 130 and the financial advisor user interface 140 for rendering to the customer 110 and/or the financial advisor 120.

In certain example embodiments, the financial advice system servers 170 may be configured to optionally transmit at least a portion of the financial proposal 320 or the actionable elements 330 to one or more financial institution servers 160. These financial institution servers 160 may be associated with financial institutions where the customer 110 may hold financial accounts, such as demand deposits, term deposits, certificates of deposit, corporate bonds, sovereign bonds, credit cards, debit cards, installment loans, securities, derivatives, options, futures, swap instruments, foreign securities, debt market, retirement, non-retirement, taxable, tax-deferred, tax-exempt, and/or brokerage accounts. In some embodiments, the financial advice system servers 170 and/or the financial institution servers 160, or the combination thereof, may be configured to offer one or more proposed actions at the customer's financial institution based, at least in part, on the financial proposal 320, or portions thereof. These proposed actions may include, for example, one or more debit and/or credit transactions, one or more buy, sell, and/or exercise transactions, and/or one or more portfolio or account type conversion transactions.

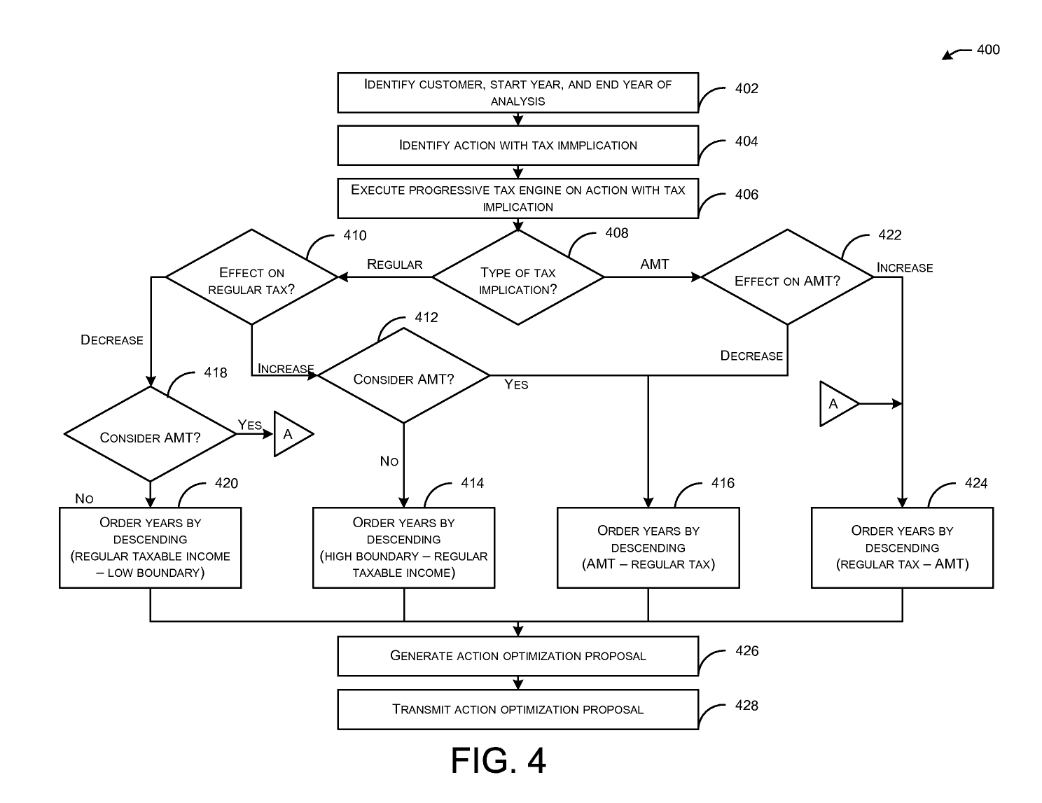

Referring now to FIG. 4, an example method 400 for generating and transmitting a financial proposal, in accordance with illustrative embodiments of the disclosure, is discussed. This method 400 may be performed by the financial advice system servers 170 and the processors 200 thereon, in cooperation with one or more other entities of the ecosystem 100.

At block 402, a particular customer and boundary years (start and end years) may be identified. In certain embodiments, this information (customer identity, start year of analysis, and end year of analysis) may be obtained from either or both of the customer 110 and/or the financial advisor 120. This information may be used by both the progressive tax engine component 182 and financial action optimization engine component 184. In some cases, default values for the boundary years may be used. For example, the start year could be set to the current year and the end year may be set based, at least in part on the customer's current age and current life expectancy. In some cases, the end year may be set to an expected death year of the customer 110 based on current life expectancies.

At block 404, an investment or other type of financial action that may have a tax implication may be identified. Certain financial actions may be independent of market value at the time of the action, while others may be dependent, at least in part, on market value. Some examples may include actions that may have at least regular tax implications, exercise of a non-qualified stock option (NSO), charitable donation (cash, securities, non-cash), purchase or sale of securities, debt, and/or derivatives, conversion of a traditional IRA to a Roth IRA, accelerated depreciation, actions that may have AMT implications, exercise of incentive stock options (ISO), and/or conversion of a traditional IRA to a Roth IRA. Particulars elements and/or values of the desired action may also be identified, such as particular securities, total amount (e.g. shares or monetary value) associated with the financial action.

At block 406, relevant data for the identified customer may be obtained from the profile database 220 and/or the comprehensive cash flow database 222. The progressive tax engine component 182 may be invoked to iteratively calculate the Federal tax obligation for each year between the identified start year and end year. As necessary, values may be converted from future value to present value for certain uses and in certain embodiments. Results (which include both regular tax and alternative minimum tax projections) from the iterative function may be written to the progressive tax database 224 for subsequent use. Selected one or more values from the Federal tax obligation calculations may also be stored on the comprehensive cash flow database 222 for subsequent use.

Some example values that are determined and/or calculated by the progressive tax engine component 182 by the iterative function may include for each year in the span of years, the regular taxable income, AGI, the regular tax obligation, the Alternative Minimum Tax (AMT) obligation, the effective tax rate (tax bracket), the “low boundary” income of the tax bracket (i.e. the lowest threshold income level and/or AGI of that particular tier of tax rate), and the “high boundary” income of the tax bracket (i.e. the highest threshold income level and/or AGI of that particular tier of tax rate).

At block 408, the type of tax implication of the identified action may be determined to be either a regular tax implication that may or may not have to be considered relative to AMT, or an AMT tax implication. If it is determined that the tax implication is regular tax, then the method may proceed to block 410, where the effect of the financial action on the regular tax may be determined. In particular, a determination may be made as to whether the financial action will reduce or increase regular tax obligation of the customer 110. For example, a charitable donation will reduce regular tax obligation, while an exercise of a NSO will increase regular tax obligation.

If it is determined that the financial action may result in an increase in the regular taxes, then at block 412, it may be determined if AMT should also be considered in addition to the regular tax. In other words, a determination may be made as to whether only the absolute regular tax should be considered or whether the regular tax relative to the AMT should be considered. An example of a financial action which may increase regular tax but should be considered relative to AMT is the exercise of a NSO.

If at block 412, it is determined that AMT need not be considered, then at block 414, the years between the start year and the end year are ordered in descending excess of high boundary of the year's tax bracket over the regular taxable income. In other words, for each year of analysis between the start year and end year, the difference between the upper threshold income and/or AGI of the tax rate tier and the regular taxable income and/or AGI may be calculated and then numerically ordered. Separate ordered lists may be created for pre-retirement and post-retirement to facilitate later processing.

If, however, at block 412, it is determined that AMT should be considered, then at block 416, the years between the start year and the end year may be ordered in descending excess of AMT over regular tax. Separate ordered lists may be created for pre-retirement and post-retirement to facilitate later processing.

If at block 410, it was determined that the effect on regular tax may be a reduction of the regular tax, then at block 418, it may be determined if AMT should be considered. In other words, a determination may be made as to whether only the absolute regular tax should be considered or whether the regular tax relative to the AMT should be considered. An example of a financial action that may reduce regular tax but should be considered relative to AMT is accelerated depreciation.

If it is determined, at block 418, that the regular tax implication relative to the AMT for the financial action should not be considered, then at block 420, the years between the start year and the end year may be ordered in descending excess of regular taxable income over the low boundary of the respective year's tax bracket. In other words, for each year of analysis between the start year and end year, the difference between the lower threshold income and/or AGI of the tax rate tier and the regular taxable income and/or AGI may be calculated and then numerically ordered. Separate ordered lists may be created for pre-retirement and post-retirement to facilitate later processing.

If it is determined, at block 418, that the regular tax implication relative to the AMT for the financial action should be considered, then at block 424, the years between the start year and the end year may be ordered in descending excess of regular tax over AMT. Separate ordered lists may be created for pre-retirement years and post-retirement years to facilitate later processing.

If at block 408, it was determined that that the type of tax implication was AMT, then the method 400 may proceed to block 422, where the effect on the AMT may be determined. In other words, a determination may be made as to whether the financial action will reduce or increase AMT tax obligation. For example, an exercise of an ISO will increase AMT tax obligation, as will (typically) the conversion of a traditional IRA to a Roth IRA. If it is determined that the effect on the AMT by the financial action may be a reduction in the AMT, then the method 400 may proceed to block 416, where the years between the start year and the end year may be ordered in descending excess of AMT over regular tax. Otherwise, the method may proceed to block 424, where the years between the start year and the end year may be ordered in descending excess of regular tax over AMT.

After executing one of blocks 414, 416, 420, or 424, the method may proceed to block 426, where a financial proposal associated with the financial action may be generated. The resulting financial proposal may include identification of one or more optimal years, both pre-retirement and post-retirement, as applicable, and associated action amounts for each year. The financial proposal may be transmitted for presentation to either or both the financial advisor 120 or customer 110, such as via the financial advisor user interface 140 or customer user interface 130. The financial proposal may be presented via either a display or a report. Alternatively, the financial proposal, or portions thereof, may be transmitted to the financial institution servers 160 for generation of trade tickets, or other proposed actions.

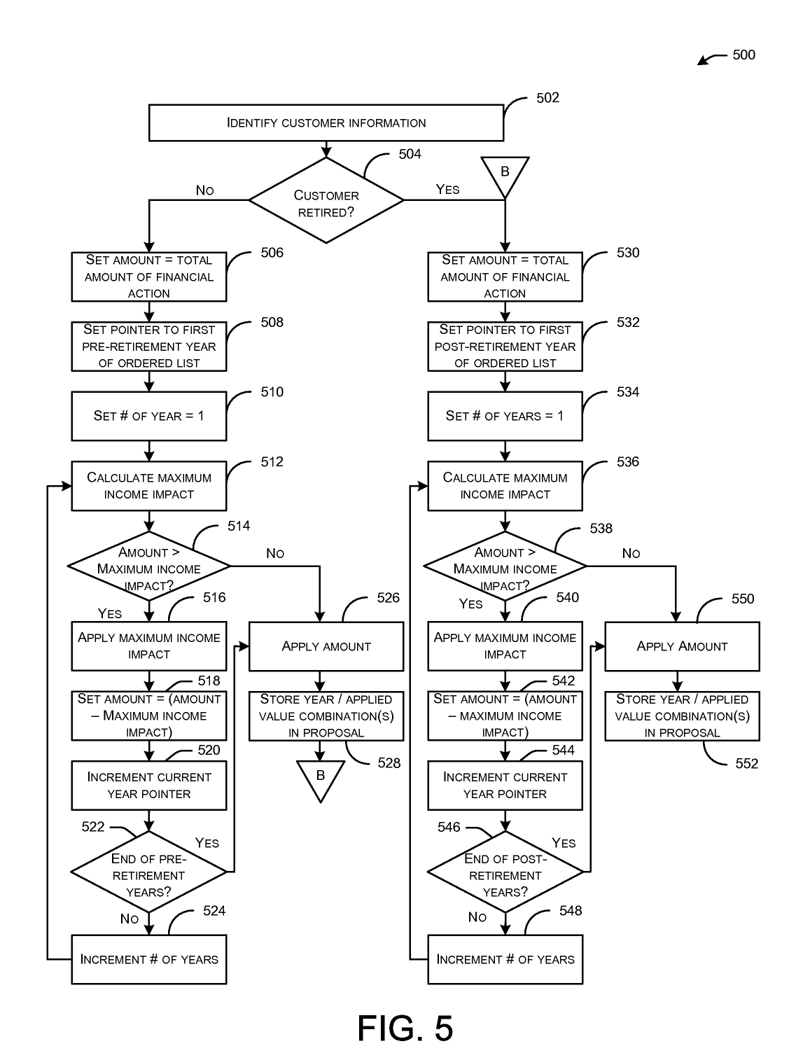

Referring now to FIG. 5, a flow diagram illustrating an example method 500 for generating a financial proposal, in accordance with illustrative embodiments of the disclosure, is described. This method 500 may be performed by the financial advice system servers 170 in cooperation with one or more other entities of the ecosystem 100.

At block 502, information associated with the customer, such as profile information, may be identified. This information may be used by the processors 200 to perform subsequent processes of method 500. At block 504, it may be determined if the customer 110 is retired. It will be appreciated that if the customer 110 is not retired, the financial proposal 320 may include recommendations for both the remaining pre-retirement period and the retirement years. However, if the customer 110 is already retired, the financial proposal 320 may only include recommendations for the remaining retirement period.

If the customer 110 is not retired, then the method 500 may proceed to block 506, where an amount variable may be initially set to the total amount of the financial action (e.g., total value of desired charitable donation, stock option exercise, IRA conversion, etc.). This value may be decremented by further processing, such as by the processes of blocks 516, 518, if it is determined that it may be advantageous to spread and/or distribute the total amount over more than one year.

At block 508, a current year pointer may be set to the first pre-retirement year in the ordered list. This may control which year is processed in a loop including processes of block 512-524.

At block 510, a variable for the number of pre-retirement years to be included in the financial proposal may initially be set to one. This factor may be utilized for one or both of spreading some remaining amount over the years in the proposal (block 526) and/or preparing the proposal content (block 528).

At block 512, a maximum allowed income impact for the current year may be calculated. For situations in which only the regular tax is considered, this maximum income impact may be the difference between the regular taxable income for the current year and one of: (i) the low boundary income for the current year's tax bracket; or (ii) the high boundary income of the current year's tax bracket. For situations in which the regular tax obligation is considered relative to the AMT tax obligation, a difference between the regular tax obligation for the current year, and the AMT tax obligation for the current year may first be determined, if the AMT is non-zero. Then the maximum income impact may be calculated by applying the inverse of the current year's effective tax rate to this difference. In other words:

$$Maximum Income Impact = \frac{1}{Current Year Effective Tax Rate} ( Difference )$$

On the other hand, if the AMT for the current year is zero, then the difference may be based on the regular taxable income relative to one of the low boundary and the high boundary, as in the situations when AMT is not considered.

At block 514, a determination may be made as to whether the value in the amount variable (initially set by the process of block 506 and subsequently decremented in the process of block 518) is greater than the maximum income impact calculated by the process of block 512. If it is, then at block 516, a portion of the financial action amount equivalent to the maximum income impact value may be applied to generate a portion of the financial proposal.

In the situation where only the regular tax obligation is considered, the portion of the financial action that is applied to the current year is the difference between the current year's regular taxable income and the appropriate one of the low boundary or high boundary income for the current year tax bracket (increasing the taxable income up to the high boundary income but no higher, or reducing the taxable income down to the low boundary income but no lower).

In the situation where the regular tax obligation is considered relative to the AMT tax obligation, the portion of the financial action that is applied to the current year is an amount that generates a tax obligation increase/reduction equal to the difference between the regular tax and the AMT for the current year (increasing the regular tax up to the AMT but no higher, or reducing the AMT down to the regular tax obligation but no lower).

At block 518, the amount variable may be decremented by the maximum income impact value. At block 520, the current year pointer may be incremented to the next pre-retirement year in the ordered list. At block 522, it may be determined if the current year is the end of the pre-retirement years. If it is not, then the method 500 may proceed to block 524, where the number of pre-retirement years to be included in the financial proposal may be incremented and the method 500 may return to block 512.

If, however, at block 522 it is determined that the current year pointer is the end of the pre-retirement years, or if at block 514, it was found that amount variable is less than the maximum income impact calculated by the process of block 512, then the method 500 may proceed to block 526, where any remaining amount is applied in any suitable manner. In certain embodiments, the remaining financial action amount may be less than the calculated difference, and any remaining financial action amount may be applied to one or more pre-retirement years already included in the financial proposal.

For situations in which the process of block 526 is reached before the end of the list of years is considered, the same approach to applying the financial action amount used in the process of block 516 may be used here (i.e. to the current year only).

In cases where the process of block 526 is reached because the end of the list of years was reached, any remaining action amount may be either spread over all the years evenly or applied to one or more years in accordance with some rule.

At block 528, the pre-retirement year and amount value pairs determined by the processes of blocks 506-526 may be stored in (either transient or persistent) memory 210 for inclusion in the financial proposal 320.

The method 500 may continue to block 530 for consideration of post-retirement years. Additionally, the method 500 may consider only the post-retirement years, starting with the process of block 530, if at block 504, it was determined that the customer 110 is retired. The sequence of blocks 530-552 may be similar to blocks 506-528, respectively.

At block 530, an amount variable may initially be set to the total amount of the financial action (e.g., total value of desired charitable donation, stock option exercise, IRA conversion, etc.). This value may be decremented by further processing if it is determined that the best thing to do is spread the total amount over a number of years.

At block 532, a current year pointer may be set to the 1st post-retirement year in the ordered list. This may control which year is processed in a loop including processes of blocks 536-548.

At block 534, a variable for the number of post-retirement years to be included in the financial proposal may initially be set to 1. This may be useful in either spreading some remaining amount over the years in the proposal (process of block 550) or preparing the proposal content (process of block 552).

At block 536, a maximum allowed income impact for the current year is calculated. For situations in which only the regular tax is considered, this maximum income impact may be the difference between the regular taxable income for the current year and one of: (i) the low boundary income for the current year's tax bracket; or (ii) the high boundary income of the current year's tax bracket. For situations in which the regular tax obligation is considered relative to the AMT tax obligation, a difference between the regular tax obligation for the current year, and the AMT tax obligation for the current year may first be determined, if the AMT is non-zero. Then the maximum income impact may be calculated by applying the inverse of the current year's effective tax rate to this difference. In other words:

$$Maximum Income Impact = \frac{1}{Current Year Effective Tax Rate} ( Difference )$$

On the other hand, if the AMT for the current year is zero, then the difference may be based on the regular taxable income relative to one of the low boundary and the high boundary, as in the situations when AMT is not considered.

At block 538, a determination may be made as to whether the value in the amount variable (initially set by the process of block 530 and subsequently decremented by the process of block 542) is greater than the maximum income impact calculated at block 536. If it is, then at block 540, a portion of the financial action amount equivalent to the maximum income impact value may be applied to generate a portion of the financial proposal.

In the situation where only the regular tax obligation is considered, the portion of the financial action that is applied to the current year is the difference between the current year's regular taxable income and the appropriate one of the low boundary or high boundary income for the current year tax bracket (increasing the taxable income up to the high boundary income but no higher, or reducing the taxable income down to the low boundary income but no lower).

In the situation where the regular tax obligation is considered relative to the AMT tax obligation, the portion of the financial action that is applied to the current year is an amount that generates a tax obligation increase/reduction equal to the difference between the regular tax and the AMT for the current year (increasing the regular tax up to the AMT but no higher, or reducing the AMT down to the regular tax obligation but no lower).

At block 542, the amount variable may be decremented by the maximum income impact value. At block 544, the current year pointer may be incremented to the next pre-retirement year in the ordered list. At block 546, it may be determined if the current year is the end of the post-retirement years. If it is not, then the method 500 may proceed to block 548, where the number of post-retirement years to be included in the financial proposal may be incremented and the method 500 may return to block 536.

If, however, at block 546 it is determined that the current year pointer is the end of the pre-retirement years, or if at block 538, it was found that amount variable is less than the maximum income impact calculated by the process of block 536, then the method 500 may proceed to block 550, where any remaining amount is applied in any suitable manner. In certain embodiments, the remaining financial action amount may be less than the calculated difference, and any remaining financial action amount may be applied to one or more pre-retirement years already included in the financial proposal.

For situations in which the process of block 550 is reached before the end of the list of years is considered, the same approach to applying the financial action amount used in the process of block 540 may be used here (i.e. to the current year only).

In cases where the process of block 550 is reached because the end of the list of years was reached, any remaining action amount may be either spread over all the years evenly or applied to one or more years in accordance with some rule.

At block 552, the post-retirement year/amount value pairs determined by the processes of blocks 530-550 may be stored in (either transient or persistent) memory 210 for inclusion in the financial proposal 320.

The method 500 may generate a single financial action optimization proposal given a particular set of facts and assumptions. The financial advisor 120 and/or customer 110 may then be able to either 1) modify certain facts or assumptions and subsequently re-execute this processing to generate a new proposal for the same financial action, or 2) modify the financial action and subsequent re-execute this processing to generate a new proposal, or 3) some of both (1) and (2).

It will be appreciated that in some cases, the financial impact (e.g. financial impact to wealth and/or income) may be substantially the same for performing the financial action in more than one range of years. For example, for a regular IRA to Roth IRA conversion, it may not make a substantial financial difference if the action is performed in a first year versus a second year. In certain example embodiments of the disclosure, multiple options that hold substantially similar financial impact may be presented to the customer 110. In these embodiments, the method 500 may be iterated multiple times to provide alternative optimized year(s) for performing the financial action, by starting at a year other than the first pre-retirement year or post-retirement year in blocks 508 and 532, respectively. In other words, by performing the method 500 multiple times, but with a different analysis start year for application of the financial action amount, different options of substantially similar financial impact to the customer 110 may be generated.

It will further be appreciated that in some cases, if more than one financial action is contemplated by the customer 110 and/or the financial advisor 120, the financial impact of those contemplated financial actions may not be independent of each other. For example, a potential financial action of exercising ISO may be contemplated at the same time as selling securities for a capital loss. In this case, while performing the ISO exercise in a particular year may increase the income and/or AGI of the customer 110 that particular year beyond the high boundary of the tax bracket. However, if the capital loss is applied in the same year as the ISO exercise, the excess over the high boundary of the tax bracket. As may be evident, at a minimum, the step-wise and/or tiered nature of the various tax brackets may lead to the non-linear and/or non-additive nature of the progressive tax analysis applied to more than financial action. The systems and methods as described herein may be applied to analyzing two or more financial action contemporaneously. In other words, the financial actions contemplated by the customer 110 may be treated in a holistic manner where interactions therebetween may be analyzed. In these example embodiments, it may be determined if there are amounts associated with different proposed financial actions, that may have opposing impact with regards to the amount relative to the maximum income impact. In this case, the opposing amounts may be applied in a manner so that the summation of the amounts are compared to the maximum income impact at blocks 514 and/or 538.

In other example embodiments, two or more financial actions may be considered by the methods and systems herein in sequence. In this case, the analysis associated with each of the financial actions may be considered and then combined after completing the individual analysis. In some cases, the combination may be performed after the user provides an acceptance of each individual recommendation associated with each of the financial actions.

It will still further be appreciated that in certain example embodiments, where a financial action may be performed in either a pre-retirement year(s) or post-retirement year(s), the processes associated with the post-retirement years (blocks 530-552) may be performed prior to the processes associated with the pre-retirement years (blocks 506-528). In some cases, the overall tax impact may be beneficial if the financial action is performed post-retirement, when the customer's income may be relatively lower and therefore resulting in a lower tax bracket than the pre-retirement years.

It will yet further be appreciated that according to further example embodiments of the disclosure, there may be a time limit associated with performing particular financial actions and the methods disclosed herein may consider the time frames in forcing the financial action to be performed prior to the time limit. For example, company issued ISO may have an expiration date, such as ten years from the date of grant. In this case, the processor 200 performing method 500 may apply the amount of the financial action to particular years prior to the expiration of the possibility of executing the financial action, even if doing so may apply an amount greater than the maximum income impact in a particular year.

It should be noted, that the method 500 may be modified in various ways in accordance with certain embodiments of the disclosure. For example, one or more transactions of the method 500 may be eliminated or executed out of order in other embodiments of the disclosure. Additionally, other operations may be added to the method 500 in accordance with other embodiments of the disclosure.

Embodiments described herein may be implemented using hardware, software, and/or firmware, for example, to perform the methods and/or operations described herein. Certain embodiments described herein may be provided as a tangible machine-readable medium storing machine-executable instructions that, if executed by a machine, cause the machine to perform the methods and/or operations described herein. The tangible machine-readable medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of tangible media suitable for storing electronic instructions. The machine may include any suitable processing or computing platform, device, or system and may be implemented using any suitable combination of hardware and/or software. The instructions may include any suitable type of code and may be implemented using any suitable programming language. In other embodiments, machine-executable instructions for performing the methods and/or operations described herein may be embodied in firmware.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

While certain embodiments of the disclosure have been described in connection with what is presently considered to be the most practical embodiments, it is to be understood that the disclosure is not to be limited to the disclosed embodiments, but on the contrary, is intended to cover various modifications and equivalent arrangements included within the scope of the claims. Although specific terms are employed herein, they are used in a generic and descriptive sense only, and not for purposes of limitation.

This written description uses examples to disclose certain embodiments of the disclosure and also to enable any person skilled in the art to practice certain embodiments of the disclosure, including making and using any devices or systems and performing any incorporated methods. The patentable scope of certain embodiments of the disclosure is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A financial advice system, comprising:
one or more memories that stores computer-executable instructions; and
one or more processors configured to access the one or more memories, wherein at least one of the one or more processors is further configured to execute the computer-executable instructions to:
identify an investor, a proposed financial action, and a span of years for consideration for the proposed financial action;
obtain, from at least one of a financial advisor or the investor, information associated with the investor, wherein the information comprises personal data associated with the investor and financial data associated with the investor; and
generate, based on processing the obtained information, a financial action optimization proposal, wherein the financial action optimization proposal comprises one or more years in the span of years for executing the financial action, and wherein each of the one or more years is associated with a respective financial amount; and
one or more network interfaces to transmit, for presentation to at least one of the financial advisor or the investor, the generated financial action optimization proposal.

2. The financial advice system of claim 1, wherein the proposed financial action comprises at least one of: (i) an exercise of a non-qualified stock option (NSO); (ii) a charitable donation; (iii) a purchase of securities; (iv) a sale of securities; (v) a conversion of a traditional individual retirement account (IRA) to a Roth IRA; (vi) an accelerated depreciation; (vii) an exercise of an incentive stock option (ISO).

3. The financial advice system of claim 1, wherein the span of years comprises a start year that is one of (i) the current year or (ii) a specifically identified start year, and an end year that is one of (iii) the year of death of the investor based on current life expectancy or (iv) a specifically identified end year.

4. The financial advice system of claim 1, wherein the span of years comprises one of: (i) pre-retirement years; (ii) post-retirement years; or (iii) both pre-retirement and post-retirement years.

5. The financial advice system of claim 1, wherein the personal data comprises at least one of: (i) a tax filing status; (ii) a number of dependents; (iii) an age of investor; (iv) an age of dependents; (v) a carryover; (vi) a carry forward; (vii) an assumption; or (viii) a goal.

6. The financial advice system of claim 1, wherein the financial data comprises information of at least one of: (i) an asset; (ii) a liability; (iii) an income; (iv) an expense; (v) a charitable donation expense; (vi) a professional expense; (vii) an estate expense; (viii) a healthcare expense; (ix) an educational expense.

7. The financial advice system of claim 1, wherein processing the obtained information comprises executing, by the one or more processors, a progressive tax algorithm.

8. The financial advice system of claim 7, wherein executing the progressive tax algorithm comprises calculating tax data comprising at least one respective tax obligation for each year in the span of years, wherein each tax obligation is at least one of: (i) a Federal regular tax obligation; or (ii) a Federal Alternative Minimum Tax (AMT) obligation.

9. The financial advice system of claim 1, wherein the financial action optimization proposal includes at least one of: (i) a financial action in a pre-retirement period; or ii) a financial action in a post-retirement period.

10. The financial advice system of claim 1, wherein at least one of the one or more processors is further configured to receive a modification to at least one of: (i) a portion of the personal data; (ii) a portion of the financial data; or (iii) the proposed financial action, and generating, by the financial advice system, a new financial action optimization proposal.

11. A method, comprising:
identifying, by a computerized financial advice system comprising one or more computers,
an investor, a proposed financial action, and a span of years for consideration for the proposed financial action;
obtaining, by the computerized financial advice system from at least one of a financial advisor or the investor, information associated with the investor, wherein the information comprises personal data associated with the investor and financial data associated with the investor;
generating, by the computerized financial advice system based on processing the obtained information, a financial action optimization proposal, wherein the financial action optimization proposal comprises one or more years in the span of years for executing the financial action, and wherein each of the one or more years is associated with a respective financial amount; and
transmitting, by the computerized financial advice system for presentation to at least one of the financial advisor or the investor, the generated financial action optimization proposal.

12. The method of claim 11, wherein the proposed financial action comprises at least one of: (i) an exercise of a non-qualified stock option (NSO); (ii) a charitable donation; (iii) a purchase of securities; (iv) a sale of securities; (v) a conversion of a traditional individual retirement account (IRA) to a Roth IRA; (vi) an accelerated depreciation; (vii) an exercise of an incentive stock option (ISO).

13. The method of claim 11, wherein the span of years comprises a start year that is one of (i) the current year or (ii) a specifically identified start year, and an end year that is one of (iii) the year of death of the investor based on current life expectancy or (iv) a specifically identified end year.

14. The method of claim 11, wherein the span of years comprises one of: (i) pre-retirement years; (ii) post-retirement years; or (iii) both pre-retirement and post-retirement years.

15. The method of claim 11, wherein the personal data comprises at least one of: (i) a tax filing status; (ii) a number of dependents; (iii) an age of investor; (iv) an age of dependents; (v) a carryover; (vi) a carry forward; (vii) an assumption; or (viii) a goal.

16. The method of claim 11, wherein the financial data comprises information of at least one of: (i) an asset; (ii) a liability; (iii) an income; (iv) an expense; (v) a charitable donation expense; (vi) a professional expense; (vii) an estate expense; (viii) a healthcare expense; (ix) an educational expense.

17. The method of claim 11, wherein processing the obtained information comprises executing, by the computerized financial advice system, a progressive tax algorithm.

18. The method of claim 17, wherein executing a progressive tax algorithm comprises:
calculating, by the computerized financial advice system, tax data comprising at least one respective tax obligation for each year in the span of years, wherein each tax obligation is at least one of: (i) a Federal regular tax obligation; or (ii) a Federal Federal Alternative Minimum Tax (AMT) obligation.

19. The method of claim 11, wherein the financial action optimization proposal includes at least one of: (i) a financial action in a pre-retirement period; or ii) a financial action in a post-retirement period.

20. The method of claim 11, further comprising receiving, by the computerized financial advice system, a modification to at least one of: (i) a portion of the personal data; (ii) a portion of the financial data; or (iii) the proposed financial action, and generating, by the computerized financial advice system, a new financial action optimization proposal.
